(19) United States
(12) Patent Application Publication
(10) Pub. No.: US 2026/0317506 A1
(43) Pub. Date: Oct. 15, 2026

(54) RECYCLABLE BLENDED FIBERS AND RELATED METHODS

(71) Applicant: Northwestern University, Evanston, IL (US)

(72) Inventors: Cecile Anne Carole Chazot, Evanston, IL (US); Eleanor Catherine Grosvenor, Houston, TX (US); Malachi Rex Cohen, Evanston, IL (US); Gabrielle Nia Wood, Conyers, GA (US)

(21) Appl. No.: 19/642,098

(22) Filed: Apr. 8, 2026

Related U.S. Application Data
(60) Provisional application No. 63/786,456, filed on Apr. 10, 2025.

(51) Int. Cl. C08J 11/16; B09B 3/80; B09B 101/75; B09B 101/85

(52) U.S. Cl. CPC C08J 11/16; B09B 3/80; B09B 2101/75; B09B 2101/85; C08J 2305/00; C08J 2375/04; C08J 2377/00

(57) ABSTRACT

Provided are methods for forming recyclable blended fibers. The recyclable blended fibers and methods for recycling these fibers are also encompassed by the present disclosure. In embodiments, a method of recycling a recyclable blended fiber comprises exposing a recyclable blended fiber comprising a core fiber comprising a core polymer, an interlayer coating on a surface of the core fiber, the interlayer coating comprising an interlayer polymer, and a sheath on a surface of the interlayer coating, the sheath comprising a sheath polymer, to a dissolution solution comprising a dissolution solvent for a period of time to remove the interlayer coating from the core fiber.

### CROSS REFERENCE TO RELATED APPLICATIONS

The present application claims priority to U.S. provisional patent application number 63/786,456 that was filed Apr. 10, 2025, the entire contents of which are incorporated herein by reference.

### REFERENCE TO GOVERNMENT RIGHTS

This invention was made with government support under DMR2308691 awarded by the National Science Foundation. The government has certain rights in the invention.

### BACKGROUND

Clothing is an important means of self-expression with nuanced social, cultural, and even political implications. Rapid trend cycles and population growth both drive the demand for new styles, leading textile manufacturers to produce 124 million tons of garments in 2024. Future garment production is projected to reach 160 million tons by 2030. This growth generates substantial waste, with the garment industry alone generating roughly 18 million tons of waste in 2020. Synthetic fibers comprise 57 percent of this waste, making them a major contributor. Due to the difficulty in separating synthetic fibers in scalable recycling streams, over 70% of clothing fibers end up in landfills or incinerated, with less than 1% recycled into new garments.

### SUMMARY

Provided are methods for forming recyclable blended fibers. The recyclable blended fibers and methods for recycling these fibers are also encompassed by the present disclosure.

The present disclosure is illustrated by reference to an Example, below, that uses a dissolvable chitosan (CS) finishing layer applied to elastane fibers, which can be selectively removed at end-of-life to enable separation from sheath fibers. A continuous dip-coating process is implemented and its feasibility is demonstrated at pilot scale using a roll-to-roll setup. By tuning solution viscosity, uniform, conformal coatings on neat elastane are achieved. A 4 wt % CS solution in 0.5 N HCl yields a 5-10 μm-thick coating that forms strong non-covalent interactions with the elastane core without compromising elastic modulus or energy dissipation under cyclic strain. The CS layer can be redissolved under mild acidic conditions, preserving the chemical integrity of the recovered elastane. The approach highlights CS dip-coating as a promising finishing strategy for scalable elastane recovery from diverse fiber blends via selective interface dissolution.

In one aspect, a method of recycling a recyclable blended fiber is provided. The method comprises exposing a recyclable blended fiber comprising a core fiber comprising a core polymer, an interlayer coating on a surface of the core fiber, the interlayer coating comprising an interlayer polymer, and a sheath on a surface of the interlayer coating, the sheath comprising a sheath polymer, to a dissolution solution comprising a dissolution solvent for a period of time to remove the interlayer coating from the core fiber.

In another aspect, a method for forming recyclable blended fibers is provided. Such a method comprises exposing a core fiber comprising a core polymer to a coating solution for a period of time, the coating solution comprising an interlayer polymer and a coating solvent, to form an interlayer coating comprising the interlayer polymer on a surface of the core fiber; and forming a sheath comprising a sheath polymer on the interlayer coating to form a recyclable blended fiber.

In another aspect, a recyclable blended fiber is provided. The recyclable blended fiber comprises a core fiber comprising a core polymer, an interlayer coating on a surface of the core fiber, the interlayer coating comprising an interlayer polymer, and a sheath on a surface of the interlayer coating, the sheath comprising a sheath polymer.

Other principal features and advantages of the disclosure will become apparent to those skilled in the art upon review of the following drawings, the detailed description, and the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Illustrative embodiments of the disclosure will hereafter be described with reference to the accompanying drawings.

FIGS. 1A-1D. FIG. 1A shows an illustration of the elastane fiber with the dip-coated CS layer as interface between the elastane and the sheath fibers to improve recycling via interface layer redissolution. FIG. 1B shows a Hansen solubility plot of relevant textile polymer fibers and CS. FIG. 1C shows a roll-to-roll (R2R) pulley system applied in the Example, below. The elastane fiber was guided into the CS bath, and then a fan was used to induce drying of the coated fiber. FIG. 1D shows several SEM images illustrating the elastane fiber, which is a bundle of 10 single filaments (plies), successfully coated with CS.

FIGS. 2A-2F. FIG. 2A shows flow curves for 25 concentrations between 0 and 7 wt % CS in aqueous 0.5 N HCl. FIG. 2B shows associated zero-shear viscosity which highlights the dilute regime, semi-dilute regime, and processing window for the bath concentrations. FIG. 2C shows TGA curves for CS, virgin elastane fiber, and coated elastane fibers (2-7 wt % bath concentrations). FIG. 2D shows average residual mass of fibers in TGA experiment at 645 °C. FIG. 2E, panels (i)-(iii), show overlayed FTIR spectra for 3 wt %, 4 wt %, 5 wt %, 7 wt % coated fibers, virgin elastane, and CS in two regions of interest: 1285-1135 cm⁻¹, and 1170-900 cm⁻¹. These regions encompass the CH₂ (CS) bend at 1258 cm⁻¹ (FIG. 2E, panel (i)), the C—O—C (CS) stretch at 1150 cm⁻¹ (FIG. 2E, panel (ii)), and the broad absorption peak for C—O—C (CS) below 1000 cm⁻¹ (FIG. 2E, panel (iii)). FIG. 2F shows a ratio of the calculated area of the C—O—C peak in the 1170-900 cm⁻¹ region to the reference peak in the 1685 to 1760 cm⁻¹ region for 3 wt %, 4 wt %, 5 wt %, 6 wt %, and 7 wt % coated fibers.

FIGS. 3A-3C. FIG. 3A shows stress-strain diagrams from cyclic tensile testing of the CS-coated elastane fibers at different CS concentrations (0 wt %, 3 wt %, 4 wt %, 5 wt %, 6 wt %, and 7 wt %) performed for 5 hysteresis cycles. FIG. 3B shows results of the elastic modulus determined from the first cycle for the different CS concentrations. FIG. 3C shows dissipated energy obtained for each cycle for the different CS concentrations by calculating area under the hysteresis curves.

FIGS. 4A-4B. FIG. 4A shows POM images of 4 wt %, 6 wt %, and 7 wt % bath concentrations demonstrating adherence of the CS coating to the fiber. FIG. 4B shows representative 10×10 μm² AFM topography images (z-scale: 400 nm) for 0 wt %, 3 wt %, 5 wt %, and 7 wt % bath concentrations.

FIGS. 5A-5B. FIG. 5A shows representative FTIR spectra of virgin elastane, 4 wt % coated fiber, and 4 wt % fiber redissolved in aqueous HCl. The region of interest is highlighted. FIG. 5B shows residual mass from TGA curves, calculated for virgin elastane and 4-5 wt % coated fibers before and after redissolution in HCl. Small circular data points represent individual trials.

### DETAILED DESCRIPTION

In one aspect, methods for forming recyclable blended fibers are provided. In embodiments, such a method comprises exposing a core fiber comprising a core polymer to a coating solution, the coating solution comprising an interlayer polymer and a coating solvent, to form an interlayer coating comprising the interlayer polymer on a surface of the core fiber; and forming a sheath comprising a sheath polymer on the interlayer coating to form a recyclable blended fiber. The interlayer coating may be in direct contact with the core fiber (forming an interlayer coating-core fiber interface an inner surface of the interlayer coating) and in direct contact with the sheath (forming a sheath-interlayer coating at an opposing outer surface of the interlayer coating).

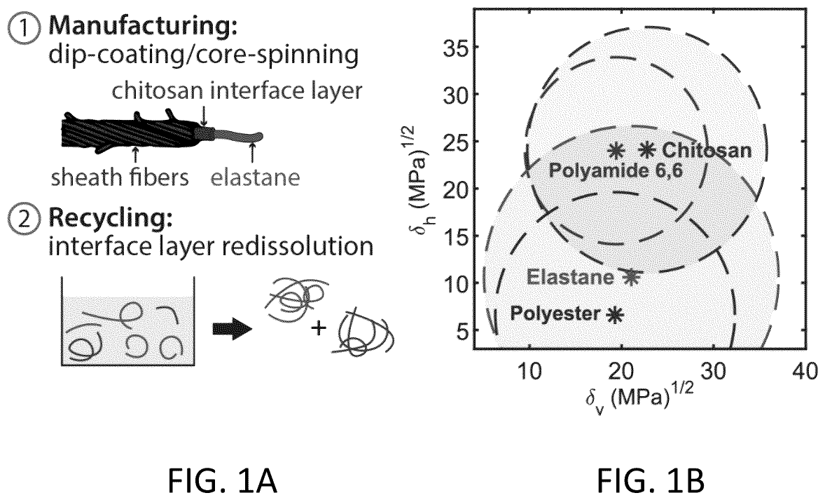

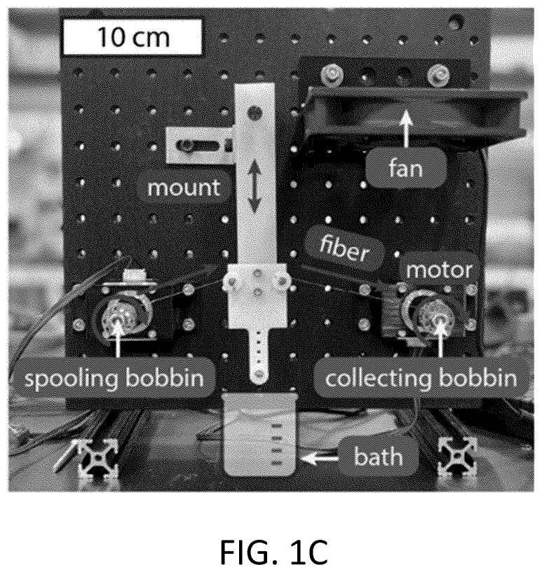

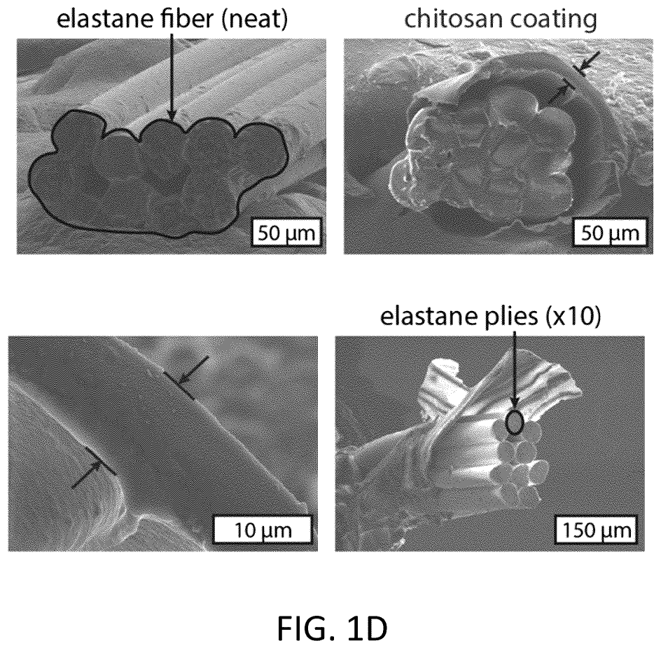

The core fiber that comprises the core polymer may be in the form of a bundle of a plurality of filaments or piles, each filament comprising the core polymer. (See FIG. 1D.) The core polymer, core fiber, sheath, and sheath polymer, are composed of the types of polymers used to form fabrics and textiles, e.g., for clothing. Thus, a variety of core polymers and sheath polymers may be used. Generally, the core polymer and sheath polymer are not the same type of polymer, i.e., their chemical compositions differ. The core polymer may be a natural polymer such as cotton or cellulose. The core polymer may be a synthetic polymer such as a polyester or elastane. Elastane is also known as spandex or LYCRA®. Elastane fibers contain at least 85% polyurethane-polyurea, a linear block copolymer with alternating rigid and flexible segments. The flexible segments allow elastane to be reversibly stretched by up to 600 percent, while the rigid segments participate in hydrogen bonding, providing strength to the fiber. The balance between elasticity and tenacity of elastane yarn can be modulated simply by changing the denier (mass in grams of 9,000 meters of fiber).

The sheath polymer may be a natural polymer such as cotton or wool. The sheath polymer may be a synthetic polymer such as a polyamide (e.g., a nylon such as polyamide 66) or a polyester. The sheath on the core fiber (with the interlayer coating therebetween) may be formed by twisting the sheath polymer (itself which may be in the form of a sheath fiber comprising a bundle of a plurality of filaments comprising the sheath polymer) around the core fiber as is done via core spinning. This provides the recyclable blended fiber with a core-spun architecture. (See FIG. 1A.)

The coating solution comprises the interlayer polymer and the coating solvent. Interlayer polymers may be selected by using a Hansen solubility parameter analysis as described in the Example, below. (See FIG. 1B.) Suitable interlayer polymers are those that are chemically compatible with selected core and sheath polymers; soluble in a coating solvent and under conditions that do not dissolve the selected core and sheath polymers; and environmentally friendly. In embodiments, the interlayer polymer is a polysaccharide. Illustrative polysaccharides include chitosan, a cellulose acetate, a cellulose ether, or combinations thereof. Modified polysaccharides with tailored pendant groups or copolymerized with other synthetic polymers may also be used, e.g., hydroxypropyl chitosan, chitosan phenylcarbamate, or copolymers of polysaccharides and polyesters. The coating solvent is also selected on the basis of its ability to dissolve the interlayer polymer, generally under mild conditions (e.g., atmospheric pressure and room temperature), and inability to dissolve the selected core and sheath polymers under these conditions. In embodiments, the coating solvent is an aqueous acidic (e.g., HCl) solution. Acidic aqueous solutions may have a pH of less than 3, less than 2.5, less than 2, less than 1.5, or a range of between any of these values, including from 1 to 3. Lactic acid and 1,3-propanediol are other illustrative coating solvents. Deep eutectic solvents (such as those formed by urea and choline chloride) and ionic liquids (such as 1-Ethyl-3-methylimidazolium dicyanamide) may be used as coating solvents. Combinations of these coating solvents may be used in the coating solution.

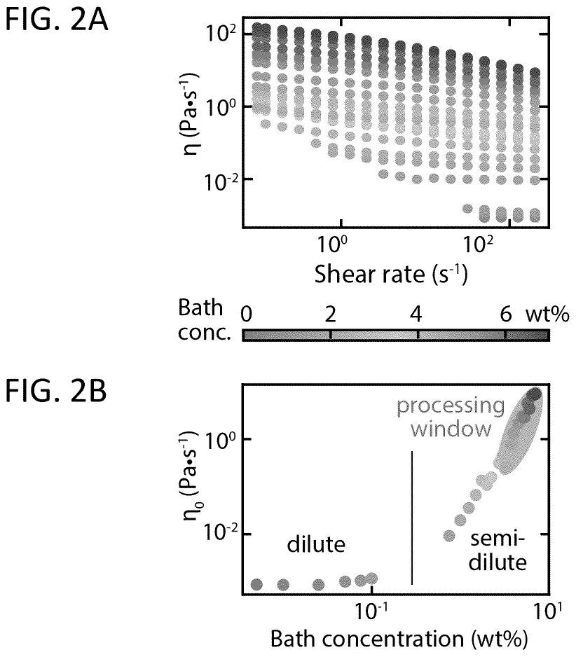

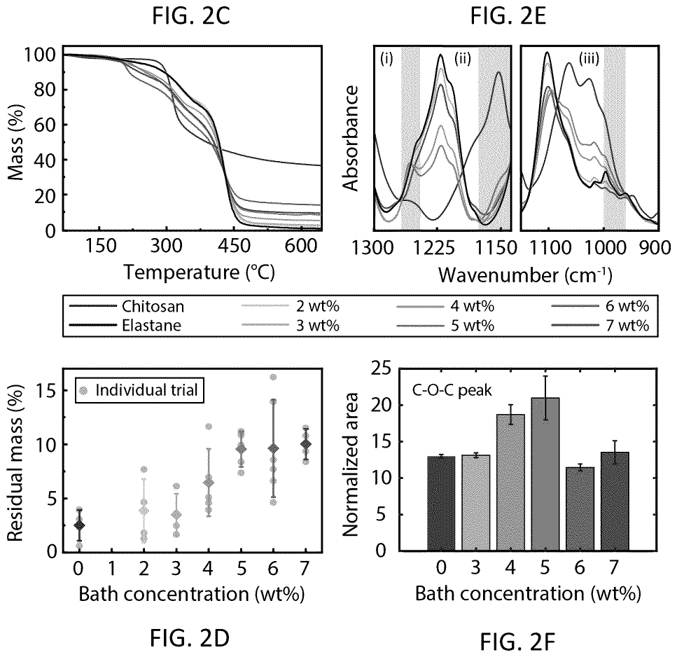

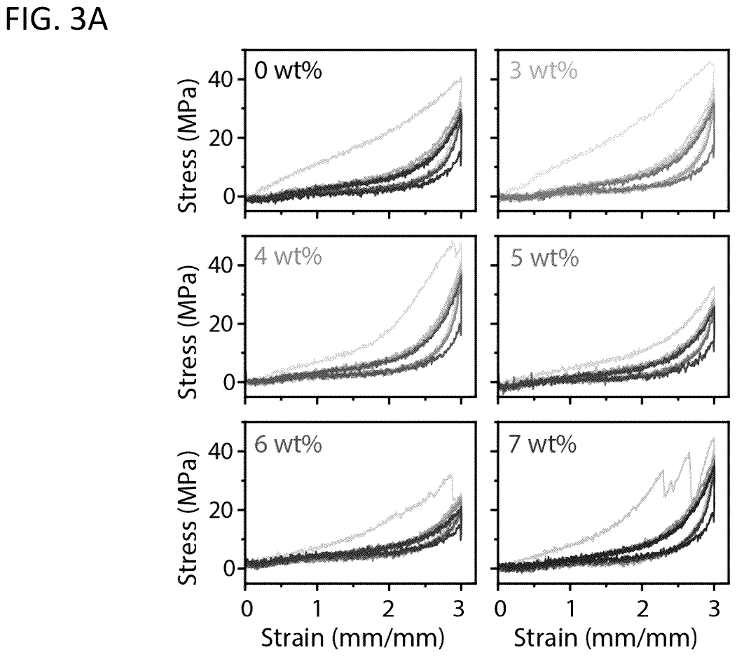

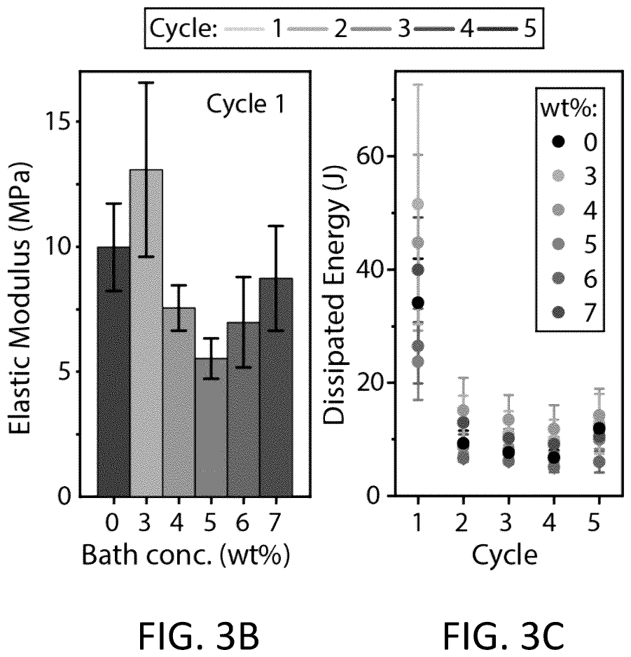

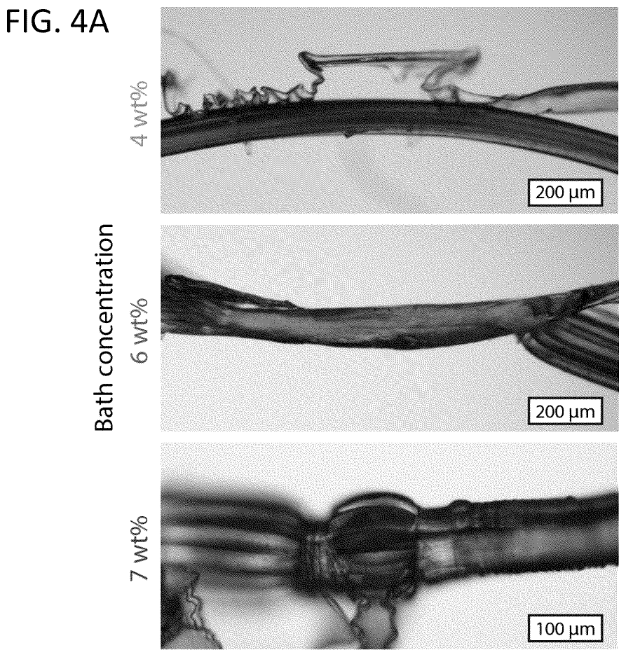

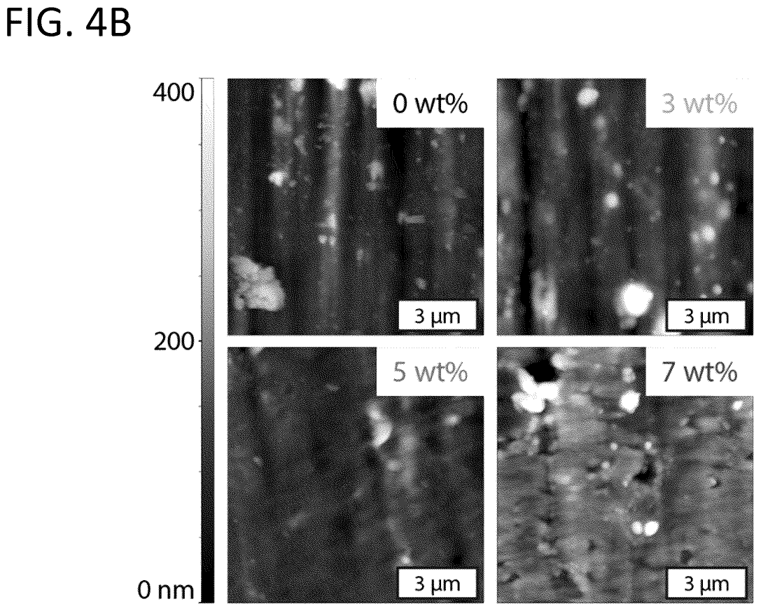

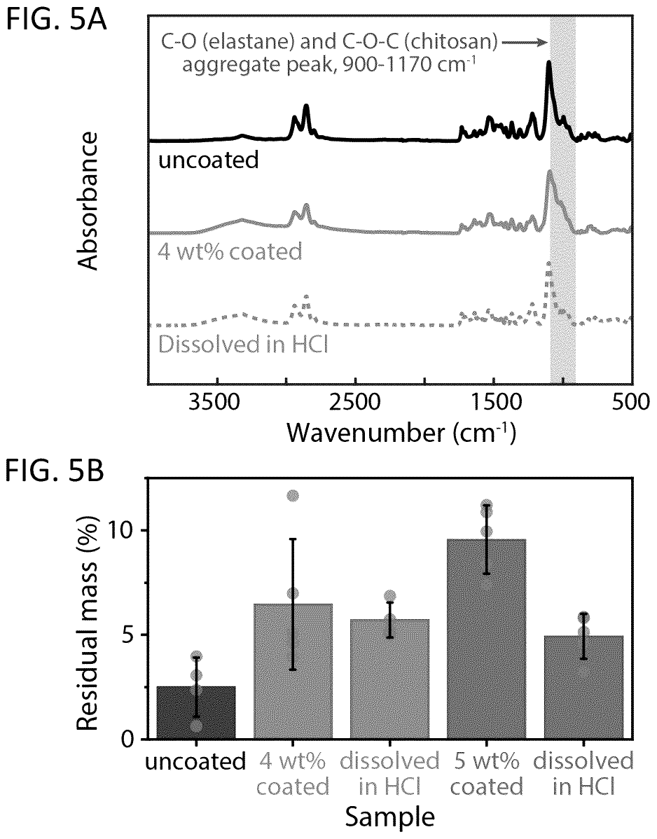

The amount of the interlayer polymer in the coating solution is generally selected to ensure a uniform and conformal coverage of the interlayer polymer on exposed surfaces of the core fiber. As demonstrated in the Example, below, only certain concentrations may be able to provide uniform and conformal interlayer coatings. (See FIGS. 2A, 2D, 4A.) The amount may also be selected to ensure adhesion of the interlayer polymer to the core fiber (which may be confirmed using FTIR analysis as shown in FIGS. 2F and 5A) with minimal effects on the mechanical properties of the core fiber (which may be confirmed using mechanical testing as shown in FIGS. 3A-3C) or the morphology of the core fiber (which may be confirmed using AFM images as shown in FIG. 4B). Thus, confirmation of adhesion and lack of effect on mechanical properties and morphology may comprise obtaining any of the test results for the coated core fiber as compared to the uncoated core fiber as described in the Example, below. In embodiments, the amount of the interlayer polymer in the coating solution may be in a range of from 3 weight % to 7 weight %, including 4 weight %, 5 weight %, 6 weight %, and a range between any of these values. (In embodiments, “weight %” refers to (weight of interlayer polymer)/(total weight of coating solution)*100. In embodiments, “weight %” refers to (weight of interlayer polymer)/(weight of interlayer polymer+weight of coating solvent)*100.)

Other components may be included in the coating solution, e.g., a plasticizing agent such as glycerol. These other components may be present in the interlayer coating.

The morphology of the interlayer coating, including its uniformity and conformality, may be evaluated using scanning electron microscopy (SEM), polarized optical microscopy (POM), and atomic force microscopy (AFM) as described in the Example, below. The thickness of the interlayer coating may be in a range of from 5 mm to 10 mm, including 6 mm, 7 mm, 8 mm, 9 mm, and a range between any of these values. The thickness refers to the dimension measured from cross-section images (e.g., SEM images) of a coated core fiber and may refer to an average value measured at multiple points across a coated core fiber. (See FIG. 1D.)

The exposure of the core fiber to the coating solution may be carried out, e.g., via dip coating, including using a roll-to-roll process as illustrated in FIG. 1C and described in detail in the Example, below. Parameters of the roll-to-roll process may be selected to ensure the interlayer coating characteristics as described above. Otherwise, the conditions used are mild, e.g., the coating solution through which the core fiber passes may be under ambient pressure and at room temperature. After exposure of the core fiber to the coating solution, the coating solvent is removed, e.g., by drying.

In embodiments, a surface pretreatment, (e.g., silanization, plasma, UV-ozone, or other chemical functionalization) may be applied to the core fiber prior to exposure to the coating solution. Fixative agents that enable the formation of a coordination complex (e.g., metal salts, like alum, iron, or copper) may be used. The surface pretreatment may enhance adhesion between the core fiber and the interlayer coating. Surface pretreatment encompasses washing the core fiber, e.g., with water, an aqueous solution, or an organic solution (e.g., hexane), prior to exposure to the coating solution.

In embodiments, a post-treatment may be carried out on the interlayer coating after it is adhered to the core fiber, e.g., to enhance adhesion with the sheath. One type of post-treatment comprises exposing the coated core fiber to an alkaline solution (pH>8) to neutralize acidic groups on the interlayer polymer of the interlayer coating.

The methods described above provide a recyclable blended fiber comprising the core fiber comprising the core polymer; the interlayer coating on the surface of the core fiber, the interlayer coating comprising the interlayer polymer; and the sheath comprising the sheath polymer on the surface of the interlayer coating. Any of the disclosed core fibers, core polymers, interlayer coatings, sheaths, and sheath polymers may be used. The recyclable blended fibers are also encompassed by the present disclosure. As shown in FIG. 1A, the recyclable blended fibers have a coaxial, concentric structure with a central core fiber enveloped by the interlayer coating, which is in turn, enveloped by the sheath.

In another aspect, methods for recycling the recyclable blended fibers are provided. Such a method comprises exposing any of the disclosed recyclable blended fibers to a dissolution solution comprising a dissolution solvent for a period of time to remove (e.g., completely) the interlayer coating from the core fiber. The core fiber may then be recovered from the dissolution solution. The interlayer coating may also be removed from the overlying sheath, which may also be recovered from the dissolution solution. The dissolution solvent of the dissolution solution may be the same as the coating solvent used to form the interlayer coating. As described above, this coating/dissolution solvent (and the conditions used during dissolution) can dissolve the interlayer coating without dissolving the core fiber or the sheath. In addition, the coating/dissolution solvent and conditions used during dissolution may leave the core fiber intact and having properties (e.g., morphology, chemical, mechanical) that are the same as for an uncoated core fiber that has not be subjected to the dissolution solution.

### EXAMPLE

This Example demonstrates that a dissolvable, biopolymeric interfacial coating can be applied to elastane fibers and subsequently redissolved to enable facile and universal separation of elastane fibers from blended textiles. The coating, based on naturally abundant chitosan (CS), was applied in a continuous roll-to-roll (R2R) dip-coating process, with its thickness being controlled by the concentration of biopolymer and viscosity of the bath. Through this process, a 5-10 μm CS coating can be conformally applied to 10-ply elastane fibers. The effects of coating parameters on the morphology and thermomechanical properties of the CS-coated elastane fibers were examined. Lastly, it was demonstrated that coating redissolution in aqueous acidic conditions resulted in the recovery of elastane fibers.

### Experimental

### Materials

Chitosan (CS) was purchased from Millipore Sigma (low molecular weight-50,000-190,000 Da, 75-85% deacetylated, product number 448869) and used without further purification. To confirm purity and degree of deacetylation, ¹H NMR spectra were collected at room temperature using a Bruker Avance III HD 500 MHz spectrometer equipped with a BBO 5 mm Prodigy probe using CF3COOD (δ11.50) as the solvent (data not shown). The solubility parameter of CS was determined experimentally (data not shown). Aqueous hydrochloric acid (0.5 N) was obtained from LabChem. Commercial-grade bare elastane fibers (105 denier) were used to evaluate the coating strategy on industrially relevant materials. These fibers, generously provided by The LYCRA Company, were used as received without further modification.

### Methods

Preparation of the CS bath solution. CS baths of 2-7 weight percent (wt %) concentration were prepared as follows: the relevant mass of CS powder was first added to a 25 mL cup and 10 mL 0.5 N HCl was pipetted into the dry powder. The samples were then mixed in a planetary speed mixer (FlackTek DAC 330-100 PRO SpeedMixer) for two minutes at 2500 RPM in ambient conditions. This mixing step was repeated after at least 10 minutes and again after one day to allow for the CS to swell and form a homogeneous solution. The total volume of the bath used for R2R operation was fixed at 20 mL to ensure consistent residence time of the fiber across all bath concentrations.

Roll-to-roll process. The R2R apparatus was designed and constructed in-house using custom-machined components. Elastane fibers were first spooled onto a stainless-steel sewing machine bobbin (the “spooling bobbin”) using a benchtop bobbin winder. To operate the R2R apparatus, the virgin fiber was attached to the shaft of a NEMA 17 stepper motor, guided through the three-pulley system and manually wound a few times onto an empty identical bobbin (the “collecting bobbin”), also coupled to a NEMA 17 stepper motor. The two stepper motors were mounted 22 cm apart on a breadboard. The pulley mount, positioned to a vertical linear rail, was then lowered into the CS bath, and its height was fixed by tightening a set screw. Each stepper motor was controlled by an L298 stepper driver interfaced with an Arduino Uno. Rotational speed of the motors was maintained at 5 RPM, corresponding to a fiber linear speed average around 0.017 cm/s depending on bath viscosity and friction within the pulleys. A DC fan, powered separately, was pointed at the coated section of the fiber to induce drying.

### Characterization

Coating thickness and morphology. Scanning electron microscopy (SEM-Hitachi SU8030) was used to observe cross-sections of coated and uncoated fibers. Prior to imaging, fibers were fractured using liquid nitrogen and coated with 18 nm of conductive osmium. Polarized optical microscopy (POM) was used to qualitatively probe coating uniformity (Nikon Eclipse LV100N-Pol Microscope, transmission mode, crossed polarization, quarter wave plate to differentiate elastane and CS coating).

Fourier-transform infrared spectroscopy (FTIR). FTIR was conducted on the CS powder and 10 cm of uncoated, coated, and redissolved elastane fibers in the range of 0-4000 cm⁻¹ (Bruker Alpha II Compact FTIR Spectrometer, Diamond ATR attachment). Water compensation and baseline correction were applied during data analysis. Peak integration was performed in Bruker OPUS, and results were normalized by calculating ratio of the peak of interest to a reference peak.

Thermal stability. Thermogravimetric analysis (TGA-Netzsch TG 209 F3 Taurus) was used to evaluate the amount of CS coated on elastane fibers. CS powder and the uncoated, coated, and redissolved elastane fibers were ramped from 75 to 650 °C at a rate of 20 °C min⁻¹ and under a N₂ purge rate of 20 mL min⁻¹. The residual mass at 645 °C was used to assess the amount of CS deposited on elastane fibers.

Rheometry of bath solutions. Steady-shear flow curves were measured using a TA instruments HR-30 equipped with a 25 mm titanium plate and a Peltier plate to maintain the temperature at 25 °C. A solvent trap was used to prevent evaporation. The shear rate ranged from 0.1 to 200 s⁻¹ with a 10-s equilibration time and a 10-s averaging time. These same conditions were performed on water to obtain the torque limit of the experimental setup. Data was excluded below the point at which the stress falls below the torque limit.

Mechanical testing. Uniaxial stress/strain curves and mechanical hysteresis data were collected for the uncoated and coated elastane fibers (Test Resources 510 E1 All Electric Dynamic Testing Machine). Samples were prepared at least 24 hours before testing. A gauge length of 12.5 mm and extension speed of 508 mm/min was used. The deformation profile of the mechanical testing consisted of five cycles of stretching the fiber to 300% strain, followed by the release of tension to allow for complete recovery of the fiber. On the fifth cycle, the fiber was held at 300% strain for 30 seconds to evaluate the decay in stress. The strain was then applied at the same extension speed for a sixth cycle, in which the fiber was stretched until failure (data not shown).

Surface morphology. Atomic force microscopy (AFM) images of 10×10 μm² scan size were acquired using a Tosca™ 400 atomic force microscope (Anton Paar, Austria) in tapping mode. Silicon cantilevers (AP-ARROW-NCR from NanoWorld AG, Neuchatel, Switzerland) with a nominal force constant of 42 Nm⁻¹ and tip radius of <10 nm were used. All measurements were conducted at room temperature. Of the untreated fibers and the fibers coated with 3, 5 and 7 wt %, at least two images per fiber were scanned on three different fibers, and representative images were selected. Image processing was performed with Gwyddion v2.58 software. Background subtraction was applied with a polynomial degree of two for all presented AFM images to improve the visualization of the surface and remove the fibers' natural curvature.

Redissolution of interfacial layer. To redissolve the CS layer, the coated fibers were placed directly into the HCl bath and stirred at 300 RPM for one hour. Samples were then dried in ambient conditions for 24 hours before further characterization.

Water resistance of interfacial layer. To test the durability of the CS coating in water, the coated fibers were submerged into a water bath and gently stirred for 30 seconds. Samples were then dried in ambient conditions for 24 hours before further characterization.

### Results and Discussion

### Coating Design and Roll-to-Roll Implementation

First, Hansen solubility parameters (HSP) were used to select a relevant dissolvable interfacial coating polymer to enable facile and universal separation of elastane fibers from blended textiles. To achieve this, the coating must satisfy the following criteria (FIG. 1A): (1) it must feature chemical compatibility with the elastane core and sheath fibers to enable sufficient adhesion; (2) it must be soluble in mild conditions that do not dissolve either elastane or the blended materials; and (3) it must be environmentally friendly and naturally abundant. Hansen's definition of the dispersive (δ_{d}), polar (δₚ), and hydrogen (δₕ) solubility parameter components was followed such that the total solubility parameter is defined as:

δ_{T}=(δ²_{d}+δ²ₚ+δ²ₕ)²

The interaction between CS, elastane and relevant sheath fiber materials was then represented graphically (FIG. 1B), where δᵥ=(δ²_{d}+δ²ₚ)² and δₕ were used as the axes. This 2D representation is an effective way to visualize polymer-polymer interactions. Compounds that feature strong interaction with a given polymer fall into a circular region centered on the solute coordinates (δᵥ, δₕ) called the solubility circle. To satisfy criterion (1), the interfacial coating polymer solubility circle must overlap with that of both elastane and common synthetic sheath fibers, including polyamide 6,6 and polyester (i.e. polyethylene terephthalate). Among natural and abundant biopolymers, CS's solubility circle offers significant overlap with that of synthetic fibers of interest. CS contains hydroxyl and amino functional groups that enable strong hydrogen bonding with rigid urethane segments on the elastane backbone. It is also soluble in dilute acidic solutions for a reasonable range of molecular weights, degrees of deacetylation, and concentrations, satisfying criterion (2). Last, from a sustainability standpoint, CS was an attractive option due to its biodegradability and nontoxicity, satisfying criterion (3). This polysaccharide has also demonstrated flame retardancy, a useful property in the garment industry.

This preliminary analysis, in which CS was found to satisfy all three criteria based on HSP analysis and sustainability targets, guided the selection of CS dissolved in dilute aqueous HCl as the bath solution for continuous dip-coating of elastane fibers. To automate this process and underscore its scalability, a benchtop roll-to-roll (R2R) apparatus was designed and built (FIG. 1C). This setup was designed using a three-pulley system to guide a virgin elastane fiber into the CS bath solution, and then the coating was fan-dried before winding the coated fiber onto a clean bobbin. By setting a constant winding speed and bath residence time, and adjusting for uniform fiber tension, elastane fibers were successfully coated in a bath containing 4-7 wt % CS, as observed in SEM cross-sections (FIG. 1D). The 5-10 μm CS interface layer conformally wrapped and compressed the plies, suggesting a strong chemical interaction with elastane, as predicted by HSP analysis.

### Influence of Bath Concentration on CS Content and Interaction

With the continuous R2R process established, the impact of CS concentration and bath rheology on coating thickness was investigated (FIGS. 2A-2F). CS-HCl solutions exhibited distinct rheological regimes depending on polymer concentration, each characterized by varying degrees of shear thinning (FIG. 2A). In the first regime (C<0.75 wt %), the solutions were Newtonian. As concentration increased, the solution transitioned from the dilute to semi-dilute regime. This transition corresponded to a logarithmic increase in zero-shear viscosity η₀ (FIG. 2B) and stronger shear-thinning. It was found that only baths with CS concentrations in the semi-dilute regime (3-7 wt %, the processing window) resulted in the formation of a CS coating on elastane.

The formation of a CS coating was further confirmed by TGA (FIGS. 2C-2D). The presence of the CS coating was qualitatively supported by the characteristic shape of the mass loss curves (FIG. 2C). Increasing the CS bath concentration led to a decrease in the onset decomposition temperature. Additionally, the residual mass at 645 °C provided further evidence of increased coating thickness with higher bath concentrations (FIG. 2D). Pure CS had a residual mass of around 40%, while neat elastane had a residual mass below 3% (FIG. 2C). As CS bath concentration increased from 3 to 6 wt %, the average residual mass of the coated fibers tripled, denoting a corresponding increase in coating thickness (FIG. 2D). Bath concentrations below 3 wt % resulted in no significant residual mass increase compared to neat elastane, likely due to their low capillary number. A plateau in residual mass was also observed for CS bath concentrations above 6 wt %, attributed to the formation of a non-uniform beaded coating due to significant non-Newtonian flow effects or air entrainment. These residual mass results also demonstrated that CS coating can enhance flame retardancy of elastane fibers, a useful property for performance textiles.

FTIR spectroscopy was used to provide further evidence of successful CS coating and probe chemical interaction between CS and elastane (FIGS. 2E-2F). In the virgin elastane spectrum, there was a sharp peak at 1102 cm⁻¹ followed by a lower-intensity shoulder (between 900 and 1030 cm⁻¹) corresponding to the C—O (ether) bond. In pure CS, a strong, broad absorption peak between 800 and 1220 cm⁻¹ was present and characteristic of C—O—C in the CS saccharide repeat unit. As the concentration of the CS bath increased, an increase in absorption intensity was noted in this characteristic CS region, particularly on the lower wavenumber edge of the investigated range (below 1000 cm⁻¹) (FIG. 2E). Integrating the relevant broad aggregate peak (between 900 cm^{31 1} and 1170 cm⁻¹) and normalizing by a vibrational signature only present in the elastane signal (from 1685 to 1760 cm⁻¹, comprising the amide I and ester vibrational modes) further confirmed the increase in CS coating thickness with bath concentration in the range of 3 to 5 wt % (FIG. 2F). Fibers coated with 6 and 7 wt % CS solutions showed a lower characteristic CS signal, likely due to coating non-uniformity. It was found that fibers with a thin CS coating (4-5 wt % bath concentration) featured an amplified intensity for vibrational modes characteristic of the pyranose ring of CS (CH₂ bending at 1258 cm⁻¹ and asymmetric stretching of the C—O—C bridge at 1150 cm⁻¹) (FIG. 2E). This suggested significant molecular interaction between CS and elastane, in turn affecting the vibrational degrees of freedom of the saccharide units and their amplitude. Fibers coated in high-viscosity 6 and 7 wt % solutions did not show the same vibrational mode modulation due to coating heterogeneities and potential decrease of CS-elastane intermolecular interaction at large coating thicknesses.

### Mechanical Properties of the Coated Fibers

The effect of the dip-coating process and CS coating on elastane's copolymer structure and mechanical performance was then evaluated. Preservation of crystallinity after dip-coating treatment was confirmed by WAXS, comparing the spectra for virgin elastane, 4 wt %, and 7 wt % coated fibers (data not shown). This suggested that exposure to HCl did not affect the elastane copolymer morphology and crystalline domains. Using a standardized cyclic tensile testing procedure, the impact of CS coating thickness on reversible stretchability under uniaxial periodic strain was assessed (FIGS. 3A-3C).

Elastane fibers showed a large hysteresis under cyclic load, both in the presence and absence of CS coating. The CS coating appeared to significantly affect the shape of the first load cycle, with sudden stress drops at large CS bath concentrations (FIG. 3A). Evaluating the Young's modulus for the initial slope of the first tensile load resulted in average values which were between 5 and 15 MPa, with a slight decrease with the addition of a CS coating (FIG. 3B). However, these values were calculated by neglecting variations of cross-sectional area and CS coating thickness between fibers. These variations would likely result in the observed slight variations in elastic modulus.

Hysteresis was an indication of the energy dissipated in the fiber during one loading-unloading cycle. In elastane fibers, the dissipated energy of the first cycle was about three times larger than in subsequent cycles (FIG. 3C). Comparing the energy dissipated across the CS bath concentration range, the values were very similar for the 3-4 wt % coated fibers, which exhibited slightly higher values in every cycle, while the 5-6 wt % coated fibers had lower or unchanged values compared to the uncoated fibers. Only the 7 wt % coated fibers showed stronger deviations, with higher dissipation values than the uncoated fibers in cycles 1-4. Moreover, in cycle 1, several instant drops in stress were observed at higher strain values in 7 wt % coated fibers (FIG. 3A). Macroscopic observations of individual ply failure at stress drops suggested that immersion in a high-viscosity 7 wt % bath solution resulted in decreased ply interaction and fiber weakening during the coating process.

Although CS and elastane have good chemical compatibility for adhesion, there seemed to be a mechanical mismatch between the two materials. Synthetic CS exhibited wide-ranging mechanical properties (e.g., tensile strength values range from a few MPa to 100 MPa), which were tunable to a certain degree by processing and additives. In direct comparison to elastane, which exhibited typical values of 1 MPa for tensile strength and up to 10 MPa for Young's modulus, CS was stiffer and more brittle. In most cases, CS-based films and fibers had an elongation at break below 50 %, whereas elastane reached stretchability values of up to 600 % due to its thermoplastic elastomeric nature. Therefore, it was surprising that coating elastane with CS did not lead to a significant increase in Young's modulus or decrease in dissipated energy. Observed coating lift-off, fracture, and ply separation under mechanical stress suggested that the strong mechanical property mismatch dominated macroscale adhesion properties over intermolecular hydrogen bonding.

However, a quantified description of the mechanical behavior of neat and coated elastane was complicated by variations in the fibers'structural arrangement. The elastane fibers featured ten individual plies solely interacting through weak physical or electrostatic interactions. Therefore, stretching the whole elastane fiber assembly can induce reorientation and shifting of the plies into different packing geometries. This rearrangement was observed through optical microscopy of microtome-sectioned longitudinal slices taken at multiple positions along several centimeters of a continuous elastane fiber (data not shown). This geometric reorganization of the plies likely occurred during the R2R dip-coating process of fibers under tension, particularly in high viscosity solutions (e.g., 6-7 wt % CS). Overall, mechanical property characterization indicated that the dip-coating process had minimal effect on elastane's stretchability.

However, high bath viscosity can significantly influence the stretched state and cross-sectional area of coated elastane fibers, affecting failure modes. The impact of dip-coating on ply configuration was further evaluated through direct morphological analysis of CS-coated fibers (FIGS. 4A-4B). Low magnification POM observation of the CS-coated fibers revealed that the 4 wt % coated fibers had an intact thin CS coating, while the 5-7 wt % coated fibers showed varied coating thickness, along with CS fracture and delamination along the fiber length (FIG. 4A). For a bath concentration of 7 wt % CS, regions where the coating was still intact showed significant compression of the elastane core in comparison to uncoated sections. Heterogeneities in the CS coating along the fiber direction were also accompanied by changes in coating surface morphology, as measured by AFM (FIG. 4B). Whereas the uncoated fiber exhibited the typical anisotropic linear pattern typical of the surface of spun synthetic fibers, the surface morphology evolved with increasing coating thickness. At 3 wt % and 5 wt %, the surface appeared homogeneously and conformally coated, as evidenced by the presence of the linear pattern from the underlying elastane fiber. However, fibers finished in 7 wt % solutions exhibited lateral cracks of several μmin length within the CS coating. In summary, elastane fibers finished using bath concentrations of 4-5 wt % featured the most uniform coating CS with no significant impact on the stretchability, failure mechanism, and ply morphology compared to neat elastane

### Selective Redissolution

The chemical resistance of the 4 and 5 wt % CS-coated fibers was tested by selective redissolution in aqueous 0.5 N HCl (FIGS. 5A-5B). Elastane fibers were successfully recovered from the HCl bath without visible damage or ply separation. FTIR analysis confirmed that the coating dissolution did not induce significant changes in the chemical structure of the elastane (FIG. 5A). Additionally, partial dissolution of the chitosan coating was evident from a reduction in the C—O—C stretching signal characteristic of the CS layer, following immersion. These FTIR spectra exhibited no notable differences in the region of interest between the 4 wt % and 5 wt % CS coatings (data not shown). Interestingly, TGA conducted on fibers treated with HCl for CS removal only showed a decrease in residual mass after redissolution for the 5 wt % coated fibers, while the 4 wt % coated fibers showed no change (FIG. 5B). Combined with the FTIR analysis in FIGS. 2E-2F, it was observed that the chemical interaction between CS coating and elastane fiber was stronger for thinner coatings (i.e., bath solutions of lower concentration) due to strengthened adhesion via hydrogen bonding interactions. After immersion in HCl, most of the 4 wt % coating stayed intact, while the outer layer of the 5 wt % coating was redissolved. Furthermore, both the 4 wt % and 5 wt % coated fibers had a higher residual mass than the neat elastane fibers, likely due to CS residue strongly adhered to the elastane surface. Thus, after reaching a certain coating thickness provided by the 4 wt % bath, subsequent CS did not adhere as strongly to the elastane. Overall, it was shown that selective coating redissolution allows for the recovery of neat elastane fibers with minimal residual CS adhered to the surface. The balance between coating thickness and adhesion can be tailored to improve recyclability via selective dissolution or chemical resistivity to further textile processing, such as dyeing or core-spinning.

### Conclusions

This Example showed the design and demonstration of the conformal coating of elastane fibers with CS, an abundant natural polymer that can be selectively dissolved to facilitate neat elastane recovery. The method was implemented in a pilot-scale roll-to-roll dip-coating apparatus, and the impact of bath concentration and viscosity on coating morphology was studied. CS bath concentrations of 4-5 wt % resulted in a uniform coating with the best adhesion to the elastane core. This Example demonstrated that the CS coating did not impair elastane's stretchability and that it enhanced the thermal stability of the resulting fibers. Lastly, this Example demonstrated how adjusting the thickness and spatially resolved intermolecular interactions can tailor the chemical resistance of the CS coating. This enabled selective redissolution under acidic conditions, allowing elastane fibers to be recovered without detectable mechanical or chemical degradation.

Further improvement in adhesion could be achieved by decreasing the mechanical mismatch between CS and elastane or enhancing hydrophobicity. Indeed, preliminary testing of the water resistance of the 4-5 wt % coatings and subsequent analysis by FTIR (data not shown) suggested that immersion in deionized water for as little as 30 seconds may result in some coating loss (data not shown). This redissolution behavior at neutral pH could pose challenges for textile durability during regular washing, but may be addressed by incorporating more hydrophobic biopolymers into the coating or by refining processing conditions during the finishing steps. For example, the current coating strategy does not include an acid neutralization step, which would improve the water resistance of the CS layer. Surface pretreatments (e.g., silanization and UV/ozone plasma) may also be adapted to elastane. Additionally, tuning fiber velocity to increase the capillary number during coating may enhance adhesion.

This Example serves as a proof-of-concept for scalable elastane finishing with improved recovery upon selective dissolution. It also offers critical insights into the balance of CS-elastane molecular interactions and mechanical property mismatches leading to uniform coating formation and property enhancement. The design principles and fundamental knowledge generated here can be leveraged to other relevant biopolymers, such as cellulose ethers and acetates, as dissolvable interface layers for textile recycling. This advancement broadens the applicability of the demonstrated fiber finishing and selective coating redissolution methods, paving the way for innovative recycling solutions for a wide range of blended fibers and textiles.

Additional information, including data referenced as not being shown may be found in U.S. provisional patent application number 63/786,456 that was filed Apr. 10, 2025, the entire contents of which are incorporated herein by reference.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

Unless otherwise indicated, and in recognition of the inherent nature of the techniques described herein, throughout the present disclosure, terms and phrases such as “absence,” “free,” “does not comprise,” etc. encompass, but do not require a perfect absence of the referenced entity. Similarly, terms and phrases such as “complete,” encompass, but do not require 100% completion.

Unless otherwise indicated, the term “type” as used herein refers to chemical formula such that a single type means the same chemical formula and different type means different chemical formula. Similarly, use of “more” as in “one or more types” refers to use of different types of the relevant entity. Similarly, terms such as “same” and the like, encompass, but do not require an exact correspondence of the referenced parameter/property.

Unless otherwise indicated, throughout the present disclosure, terms such as “comprising” and the like may be replaced with terms such as “consisting” and the like.

What is claimed is:

1. A method of recycling a recyclable blended fiber, the method comprising exposing a recyclable blended fiber comprising a core fiber comprising a core polymer, an interlayer coating on a surface of the core fiber, the interlayer coating comprising an interlayer polymer, and a sheath on a surface of the interlayer coating, the sheath comprising a sheath polymer, to a dissolution solution comprising a dissolution solvent for a period of time to remove the interlayer coating from the core fiber.

2. The method of claim 1, wherein the dissolution solvent dissolves the interlayer polymer under conditions used during the dissolution step but does not dissolve the core polymer under the conditions used during the dissolution step and does not dissolve the sheath polymer under the conditions used during the dissolution step.

3. The method of claim 2, wherein the conditions comprise atmospheric pressure and room temperature.

4. The method of claim 1, wherein the dissolution solvent comprises an aqueous acidic solution.

5. The method of claim 4, wherein the aqueous acidic solution has a pH of less than 3.

6. The method of claim 4, wherein the aqueous acidic solution is aqueous HCl.

7. The method of claim 1, further comprising recovering the core fiber from the dissolution solution.

8. The method of claim 1, wherein the interlayer coating is also removed from the sheath.

9. The method of claim 8, further comprising recovering the sheath from the dissolution solution.

10. The method of claim 1, wherein the interlayer polymer comprises a polysaccharide.

11. The method of claim 10, wherein the polysaccharide is selected from chitosan, cellulose acetate, cellulose ether, and combinations thereof.

12. The method of claim 1, wherein the core polymer comprises elastane.

13. The method of claim 1, wherein the sheath polymer comprises a polyamide, a polyester, or combinations thereof.

14. The method of claim 1, wherein the recyclable blended fiber has a core-spun architecture.

15. The method of claim 1, wherein the interlayer coating forms a first interface with the core fiber at an inner surface of the interlayer coating and the interlayer coating forms a second interface with the sheath at an opposing, outer surface of the interlayer coating.

16. The method of claim 1, wherein the interlayer coating has an average thickness in a range of from 5 μm to 10 μm.

17. The method of claim 1, wherein the core polymer comprises elastane, the interlayer polymer comprises chitosan, and the sheath polymer comprises a polyamide.

18. The method of claim 17, wherein the interlayer coating forms a first interface with the core fiber at an inner surface of the interlayer coating and the interlayer coating forms a second interface with the sheath at an opposing, outer surface of the interlayer coating.

19. The method of claim 18, wherein the core fiber consists of the elastane, the interlayer coating consists of the chitosan, and the sheath consists of the polyamide.

20. The method of claim 19, wherein the dissolution solution is an aqueous HCl solution having a pH of less than 3.
